(19) United States
(12) Patent Application Publication
(10) Pub. No.: US 2009/0094955 A1
(43) Pub. Date: Apr. 16, 2009

(54) Crop Conditioning Roll With Herringbone Flutes Having A Radius

(76) Inventors: Allan W. Rosenbalm, Blakesburg, IA (US); Jason C. Eubanks, Hedrick, IA (US); Charles S. Sloan, Blakesburg, IA (US); David C. Smith, Ottumwa, IA (US)

Correspondence Address: DEERE & COMPANY, ONE JOHN DEERE PLACE, MOLINE, IL, 61265, US

(21) Appl. No.: 12/248,440

(22) Filed: Oct. 9, 2008

Related U.S. Application Data
(60) Provisional application No. 60/979,265, filed on Oct. 11, 2007.

(51) Int. Cl. A01D 82/02

(52) U.S. Cl. 56/16.4 C

(57) ABSTRACT

The conditioning rolls of a crop harvester have intermeshing metal ribs arranged in a herringbone pattern, each rib comprising a pair of end-to-end segments that converge spirally from opposite ends of the roll to a centermost radius.

### CROSS-REFERENCE TO RELATED APPLICATION

This application claims priority form U.S. Provisional Patent Application 60/979,265 filed on 11 Oct. 2007.

### FIELD OF THE INVENTION

This invention relates to an improved crop conditioner roll such as is used in an agricultural mower-conditioner or the like.

### BACKGROUND OF THE INVENTION

In agriculture there is a widely known practice known as “hay conditioning” wherein the drying of mowed hay crops in the field is hastened, with a resulting reduction in weather damage, by a crushing of the crop stems. This operation substantially reduces the length of time required for drying of the stems roughly to the same length of time required for drying of the leaves, thereby reducing the overall harvesting time while simultaneously producing an improved crop. A known means for accomplishing this function is to provide two pressure rolls that are driven in opposite directions of rotation so that mowed crop stalks are grasped and passed between the rolls. Typically one roller is rotatably mounted on a fixed axis while the other roller is adjustably mounted so that the axes of the rolls can be spaced relative to one another so as to control the degree of crop compression and further to accommodate varying amounts of crop material.

Several roll configurations have been employed in an effort to process the crop and crack the covering of the stems in such a way that the stems are not chopped into short pieces and the leaves are not crushed and severed.

In some configurations the rollers are designed so that flutes intermesh such that crop stems are cracked open transversely at spaced sections. This type of conditioning is referred to as “crimping”. Rollers of this type tend to clutch and crack the crop rather vigorously. A drawback to this configuration is that it does not operate smoothly and does not adequately squeeze out moisture continuously along the stems.

Another type of conditioning, known as “crushing”, utilizes smooth rolls which crush the individual crop stems along their full length, thereby leaving few residual sections of concentrated moisture. However, this type of configuration is not as effective as the above-described crimping method when it comes to feeding, grasping and clutching the stalks.

Conditioning rolls having helical flutes or ribs are well known, wherein the flutes extend in a continuous spiral from one end of the roll to the other. Such helical rolls have a tendency to load up crop materials along one side of the conditioned crop discharge flow from the rolls. The resulting windrows or swaths may be less uniform than desired as a result, with heavier accumulations along one side than the other. This can have an adverse effect upon drying times and hay quality. Moreover, in many machines the cutting swath is wider than the centrally disposed inlet opening to the conditioning rolls such that outboard severed materials must be gathered centrally by augers or other means before they can enter the inlet. This increases the likelihood that the discharge flow will have heavier accumulations of materials along its sides than in the middle, in contrast to the desired goal of having the flow as uniform as possible across its entire width.

It is further known that significantly more uniform distribution can be obtained when the flute or rib pattern of the conditioning is herringbone-shaped, rather than a continuous spiral, and the rolls are constructed from a hard, non-compressible material, such as steel. A herringbone flute or rib pattern tends to naturally draw the outer materials toward the center of the rolls when the pattern is properly oriented with respect to the direction of roll rotation, and the hard, metal nature of the ribs makes their centering action even more aggressive than would otherwise be the case. This is especially beneficial in harvesters using rotary cutters as the means for severing the standing crop from the ground as these machines tend to run faster and present higher quantities of materials to the rolls in less time than sickle-type machines.

However, a significant drawback of conditioner rolls having a herringbone type flute arrangement stems from the fact that in the known designs the herringbone pattern comes to a point at the center of the roll. Testing with a herringbone fluted type conditioner roll with a point at center reveals problems with cut and chewed up crop at the center of the roll. Tests further show that the point of the herringbone flute will cause crop hesitation resulting in cut crop. Moreover, known manufacturing techniques for building such rolls involve cutting the flute at the center before twisting the flute to the roll and then welding the flute segments back together at the cut. It has also been found through finite element analysis (FEA) that the weld between flute segments at the roll center undergoes a significant amount of stress in operation and is a weak point in the construction of the roll, thus reducing the operational life of the roll to an unsatisfactory level.

### SUMMARY OF THE INVENTION

It is therefore an object of the invention to provide a herringbone fluted conditioning roll that avoids the problems set forth above with known conditioning rolls. More particularly, by twisting the flute to the roll and creating a large radius at the center, it is possible to greatly reduce crop damage in some crops and in most crops eliminate the cutting of crop in the center of the windrow. The large radius flute has a more positive feed to the crop than does the pointed flute type. It has also been found through FEA that the life of the roll is increased to a more satisfactory level when a large radius is added at the center of the roll.

### BRIEF DESCRIPTION OF THE DRAWINGS

FIG. 1 is a segmentary plan view of an exemplary conditioning roll according to the invention;

FIG. 2 is a cross sectional view of the roll of FIG. 1 taken along the line 2-2;

FIG. 3 is a cross sectional view of the roll of FIG. 1 taken along the line 3-3;

FIG. 4 is a cross sectional view of the roll of FIG. 1 taken along the line 4-4;

FIG. 5 is a color view of a Finite Element Analysis made of a prior art conditioning roll;

FIG. 6 is a color view of a Finite Element Analysis made of a conditioning roll according to the present invention; and,

FIG. 7 is a color view of a Finite Element Analysis made of a conditioning roll according to the present invention.

### DESCRIPTION OF THE PREFERRED EMBODIMENT

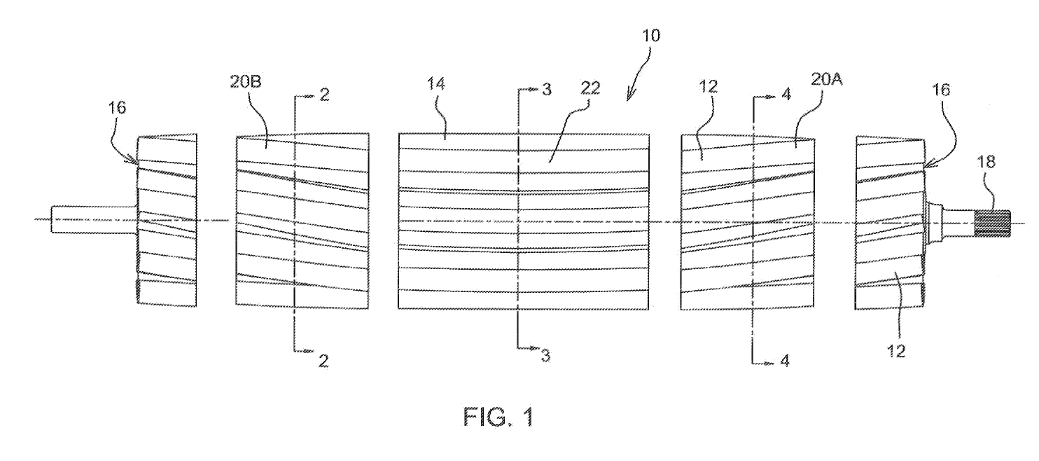

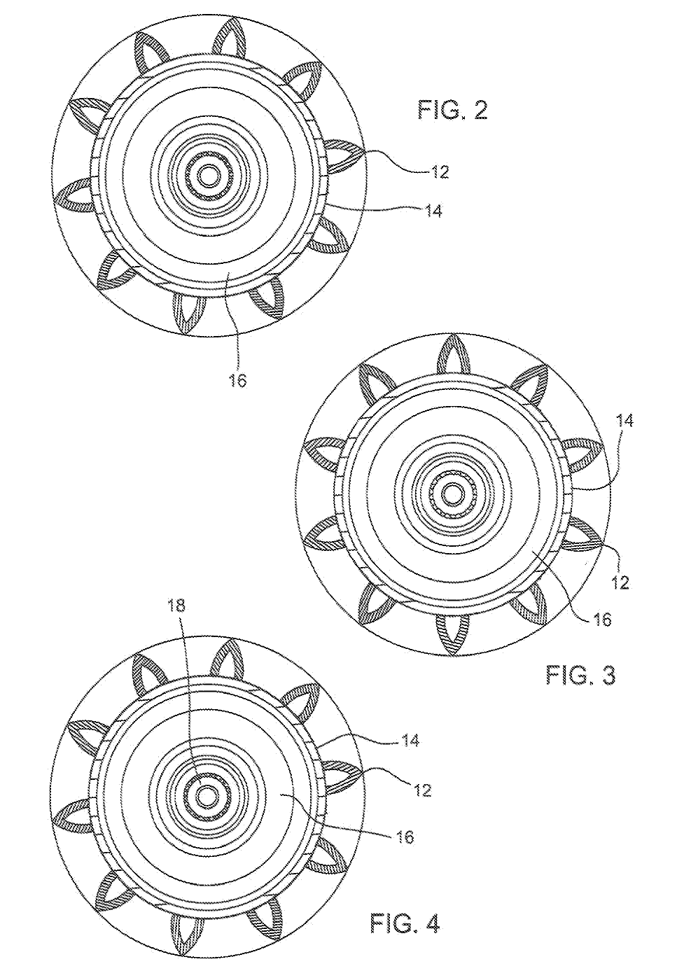

With reference to FIGS. 1-4 it can be seen that a metal conditioning roll 10 is illustrated having ribs 12 arranged in a herringbone pattern. Each herringbone roll 10 includes a cylindrical core 14 having a pair of opposite end plates 16 with stub shafts 18 projecting axially outwardly therefrom. Ten ribs 12 are spaced circumferentially around core 14 and project generally radially outwardly therefrom. In a preferred embodiment, each rib 12 is generally an ogival arch in transverse cross-section and hollow, although other configurations such as solid, transversely rectangular or triangular bars may also be utilized. Each rib 12 extends longitudinally of core 14 over its entire length. One segment 20a extends generally helically about core 14 in a right-hand spiral toward apex 22, while the other segment 20b extends helically around core 14 in a left-hand spiral from apex 22. The two rib segments 20 converge from opposite ends of core 14 toward apex 22.

Those having skill in the art will recognize that complimentary rolls 10 are identical to one another, but flipped end-for-end, so that the direction of their respective rib segments 20 is reversed relative to one another. Consequently, the ribs 12 of two rolls 10 are adapted to intermesh with one another during operation when rolls 10 are set to operate with a slight running clearance therebetween. Preferably, core 14 and ribs 12 are constructed from steel.

As illustrated particularly in FIG. 1, rolls 10 are oriented and driven in such a direction that the apexes 22 of the ribs 12 trail their opposite ends with respect to the direction of rotation and direction of crop discharge. Consequently, the herringbone rib pattern tends to gather crop centrally, rather than spread it toward opposite ends of the rolls.

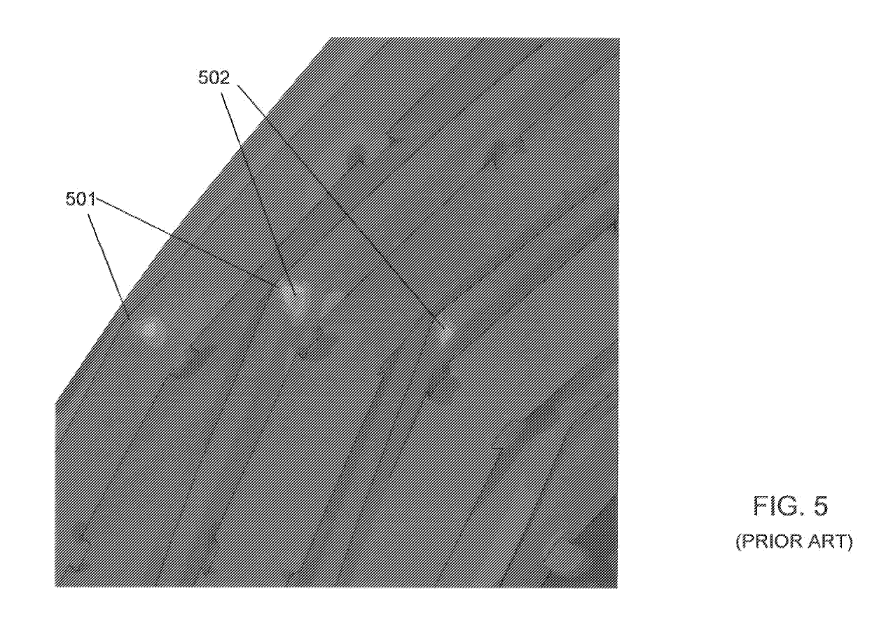

FIG. 5 illustrates the results of a Finite Element Analysis (FEA) for known herringbone rib conditioning rolls wherein there is a sharp break 501 or angularity between rib segments. The FEA clearly shows by way of yellow and orange coloration a high concentration of stress 502 at the weld between rib segments at the roll center. This area 502 undergoes a significant amount of stress in operation and is a weak point in the construction of the roll, thus reducing the operational life of the roll to an unsatisfactory level.

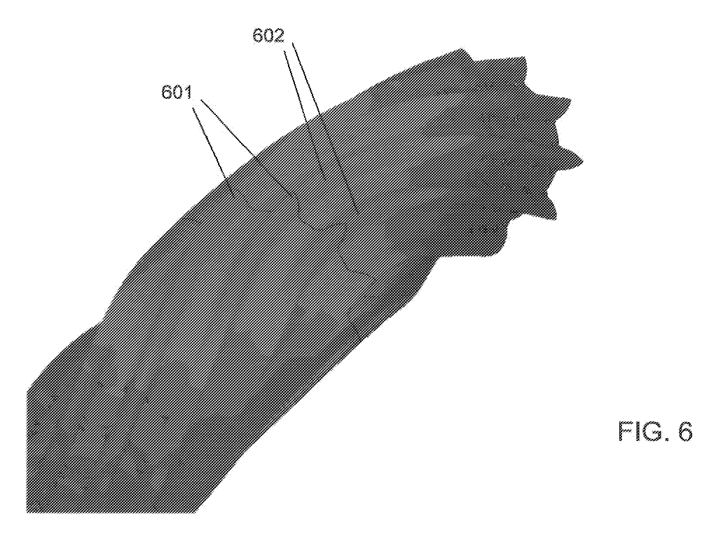

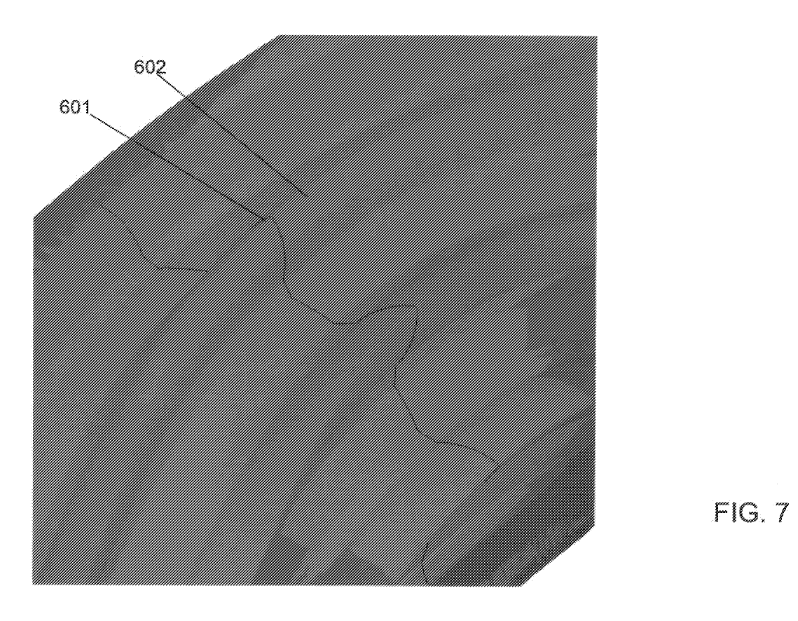

FIGS. 6 and 7 show the results of a FEA for the roll of the present invention and clearly indicate that by providing a continuous radius for each flute or rib it is possible to reduce the stress on the flute thereby increasing the life of the conditioning roll. More particularly, it can be seen in the Figures that at the apex 601 of the ribs of the conditioning roll that the coloration is blue/green 602 indicating that the stress at the apex is no greater at the apex than at any other point along the radius of the rib. Accordingly, by creating a large radius at the center, it is possible to greatly reduce crop damage in some crops and in most crops eliminate the cutting of crop in the center of the windrow and the large radius flute has a more positive feed to the crop than does the pointed flute type. As illustrated the life of the roll is increased to a more satisfactory level due to reduced stress levels when a large radius is added at the center of the roll.

Having described the preferred embodiment, it will become apparent that various modifications can be made without departing from the scope of the invention as defined in the accompanying claims.

1. A crop conditioning roll, the roll including a cylindrical core having ribs arranged in a herringbone pattern with each rib extending longitudinally of the core over its entire length with each rib having a first segment extending generally helically around the core in a right-hand spiral toward an apex and a second segment extending helically around the core in a left-hand spiral from the apex, the first and second rib segments converging from opposite ends of the core toward the apex so as to provide a continuous radius for each rib.

2. A crop conditioning roll according to claim 1 wherein the core has a pair of opposite end plates with stub shafts projecting axially outwardly therefrom.

3. A crop conditioning roll according to claim 1 wherein each rib is generally an ogival arch in transverse cross-section and hollow.

4. A crop conditioning roll according to claim 1 wherein the core and ribs are constructed from steel.

5. A crop conditioning roll according to claim 1 wherein the ribs of the roll are adapted to intermesh with ribs of a second roll which second roll is flipped end-for-end so that the direction of respective rib segments of the roll and the second roll are reversed relative to one another when the roll and the second roll are set to operate with a slight running clearance therebetween.

6. A crop conditioning roll according to claim 5 wherein the roll and the second roll are oriented and driven in such a direction that the apexes of the ribs trail their opposite ends with respect to a direction of rotation and a direction of crop discharge.
